(19) United States
(12) Patent Application Publication
(10) Pub. No.: US 2025/0131487 A1
(43) Pub. Date: Apr. 24, 2025

(54) EXPEDITING ONLINE TRANSACTIONS

(71) Applicant: Walmart Apollo, LLC, Bentonville, AR (US)

(72) Inventors: Matthew Christopher Bruer, Seattle, WA (US); Christy Torres, Jersey City, NJ (US); Pratik Ashok Nikam, Jersey City, NJ (US); Krishnan Kumbakonam Sundaresan, Seattle, WA (US)

(21) Appl. No.: 18/903,182

(22) Filed: Oct. 1, 2024

Related U.S. Application Data
(60) Provisional application No. 63/591,666, filed on Oct. 19, 2023.

(51) Int. Cl. G06Q 30/0601

(52) U.S. Cl. CPC G06Q 30/0633; G06Q 30/0617; G06Q 30/0631

(57) ABSTRACT

Systems and methods for expediting online transactions are disclosed. In some embodiments, a disclosed method includes: obtaining a query submitted by a user; identifying, in the query, at least one predetermined keyword indicating a request for an expedited transaction by the user; determining, based on the query and a transaction history of the user, a product item; generating contract data related to a purchase contract of the product item; and transmitting, as a response to the query, the contract data with an option for the user to select to directly place an order of the product item.

### CROSS-REFERENCE TO RELATED APPLICATION

This application claims benefit to U.S. Provisional Application Ser. No. 63/591,666, entitled “SYSTEM AND METHOD FOR EXPEDITING ONLINE TRANSACTIONS,” filed on Oct. 19, 2023, the disclosure of which is incorporated herein by reference in its entirety.

### TECHNICAL FIELD

This application relates generally to e-commerce and, more particularly, to systems and methods for expediting online transactions.

### BACKGROUND

To remain competitive in the marketplace, retailers are continuously looking for ways to innovate and provide new services to customers. While shopping online is usually faster than shopping in brick and mortar stores, customers still like expedited online transactions to further save their time or meet an urgent need. For example, customers shopping for groceries regularly have a desire to reduce their shopping time as much as possible, in consideration of their forever-repeating online shopping experience. This desire remains the same, if not increasing, when a customer is shopping via a handheld device, a chatbot, or any online shopping application.

### BRIEF DESCRIPTION OF THE DRAWINGS

The features and advantages of the present disclosure will be more fully disclosed in, or rendered obvious by the following detailed description of the example embodiments, which are to be considered together with the accompanying drawings wherein like numbers refer to like parts and further wherein:

FIG. 1 is a network environment configured to expedite online transactions, in accordance with some embodiments of the present teaching.

FIG. 2 is a block diagram of a chatbot serving device, in accordance with some embodiments of the present teaching.

FIG. 3 is a block diagram illustrating various portions of a system for expediting online transactions, in accordance with some embodiments of the present teaching.

FIGS. 4A-4B illustrate a user interface showing a shopping experience, in accordance with some embodiments of the present teaching.

FIGS. 5A-5D illustrate a user interface showing another shopping experience, in accordance with some embodiments of the present teaching.

FIG. 6 illustrates an example process for expediting online transactions, in accordance with some embodiments of the present teaching.

FIG. 7 illustrates another example process for expediting online transactions, in accordance with some embodiments of the present teaching.

FIG. 8 is a flowchart illustrating an example method for expediting online transactions, in accordance with some embodiments of the present teaching.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

A chatbot may refer to any software application that aims to mimic human conversation through text or voice interactions. For example, a chatbot may be a conversational or messaging application that often plugs into other applications and services (e.g., virtual personal assistants, schedulers, reminders, ordering systems, retail websites etc.), by providing users a communication interface to these other applications and services. If a user inputs a query via a chatbot for online shopping, the chatbot may provide a list of items matching the query, for the user to select for performing several subsequent actions, e.g. add to cart, go to cart, checkout, etc. But the user may desire to reduce these action steps especially when the query is for repeating shopping experience like grocery or household shopping.

The present teaching discloses systems and methods to expedite online shopping for users, by reducing the above mentioned action steps as much as possible. In some embodiments, a disclosed system uses a feature called “Buy-Now”to bypass cart actions and expedite checkout process for users shopping online via a chatbot. This feature allows customers to go from realizing a need to placing an order in one or two seconds, e.g. by a single click via the chatbot, which creates an easy way for busy customers to handle their needs in a moment.

In various embodiments, a system including a processor and a non-transitory memory storing instructions is disclosed. The instructions, when executed, cause the processor to: obtain a query submitted by a user, identify, in the query, at least one predetermined keyword indicating a request for an expedited transaction by the user, determine, based on the query and a transaction history of the user, a product item, generate contract data related to a purchase contract of the product item, and transmit, as a response to the query, the contract data with an option for the user to select to directly place an order of the product item.

In various embodiments, a computer-implemented method is disclosed. The computer-implemented method includes: obtaining a query submitted by a user; identifying, in the query, at least one predetermined keyword indicating a request for an expedited transaction by the user; determining, based on the query and a transaction history of the user, a product item; generating contract data related to a purchase contract of the product item; and transmitting, as a response to the query, the contract data with an option for the user to select to directly place an order of the product item.

In various embodiments, a non-transitory computer readable medium having instructions stored thereon is disclosed. The instructions, when executed by at least one processor, cause at least one device to perform operations including: obtaining a query submitted by a user; identifying, in the query, at least one predetermined keyword indicating a request for an expedited transaction by the user; determining, based on the query and a transaction history of the user, a product item; generating contract data related to a purchase contract of the product item; and transmitting, as a response to the query, the contract data with an option for the user to select to directly place an order of the product item.

In some embodiments, after a user inputs a query during a chatbot shopping process, the system determines whether the user has an intent for expedited online transaction, based on the query. For example, if the query contains a keyword like: “now,” “asap,” “as soon as possible,” “today,” “tomorrow,” or any other word that can signify speed for the shopping process, the system enables or triggers the “Buy-Now” feature that allows the user to go directly from search to checkout.

In some embodiments, once the “Buy-Now” feature is triggered based on the query, the system can determine whether a single product item can be identified based on the query and the user's historical shopping experience. If so, the system directly generates a shopping contract for the product item, and provides the contract to the user via the chatbot as a direct response to the query. The contract may be provided based on the user's voluntarily saved information on the website or chatbot application, e.g. default shipping address, default payment method, etc. In this manner, the user can place an order of the product item directly by one click, without any other actions like check product details, add to cart, go to cart, etc.

In some embodiments, after the “Buy-Now” feature is triggered based on the query, the system may determine multiple product items based on the query and the user's historical shopping experience. That is, the system cannot nail down to a single product item based on the query and the user's historical shopping experience. In this case, the system provides several top choices of items matching the query. For example, the system can provide three items for the user to select and/or add to cart. After the user selects one of them, the system can directly generate a shopping contract for the selected item, and provides the contract to the user based on the user's voluntarily saved information on the website or chatbot application. The selected item may or may not be added to the cart of the user. In either case, the user can place an order of the selected item directly by one click, without other actions like check product details, go to cart, etc.

In some embodiments, the system can proactively notify users about their eligibility and possibility to use the “Buy-Now” feature. For example, for users who have many grocery shopping experiences, users who have premium memberships with free shipping feature, and/or users who often add to cart and go to checkout immediately after receiving a search result, the system can send email or pop-up notifications to tell them about the possibility and manner of using the “Buy-Now” feature via the chatbot. A user who wants to use the “Buy-Now” feature may voluntarily save a default shipping address and a default payment method with the chatbot or the retailer's website, before or during the first “Buy-Now” experience.

The “Buy-Now” feature allows customers to indicate an item they need, go directly to check out and bypass actions like: viewing search results, selecting search results, viewing a detailed product page, adding to cart, viewing the cart, and indicating they want to check out. Each of these actions needs an interaction with the chatbot for many seconds. With this feature, a customer does not need to keep shopping items in his memory, in a to-do list, or in an online shopping cart. While the “Buy-Now” feature is illustrated with a chatbot in the following embodiments, the “Buy-Now” feature can also be utilized with other systems and applications in a similar manner without going beyond the scope of the present teaching.

Furthermore, in the following, various embodiments are described with respect to methods and systems for expediting online transactions are disclosed. In some embodiments, a disclosed method includes: obtaining a query submitted by a user; determining, based on the query and a transaction history of the user, a product item; identifying, in the query, a predetermined keyword indicating an expedited request of the product item by the user; generating contract data related to a purchase contract of the product item; and transmitting, as a response to the query, the contract data with an option for the user to select to directly place an order of the product item.

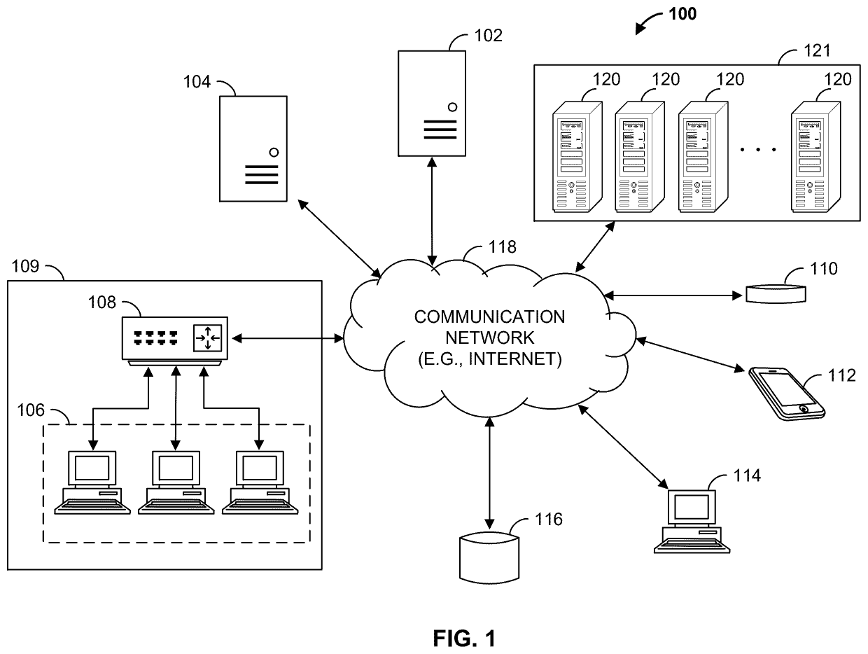

Turning to the drawings, FIG. 1 is a network environment 100 configured to expedite online transactions, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a chatbot serving device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The chatbot serving device 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the chatbot serving device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the chatbot serving device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the chatbot serving device 102, the processing devices 120, and/or the web server 104 are operated by a retailer. The multiple user computing devices 110, 112, 114 may be operated by customers or sellers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the chatbot serving device 102 over the communication network 118. The workstation(s) 106 may send data to, and receive data from, the chatbot serving device 102. For example, the workstation(s) 106 may transmit data identifying items purchased by a customer at the store 109 to the chatbot serving device 102.

Although FIG. 1 illustrates three user computing devices 110, 112, 114, the network environment 100 can include any number of user computing devices 110, 112, 114. Similarly, the network environment 100 can include any number of the chatbot serving devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate or accept a conversation with a chatbot or an application served by the chatbot serving device 102, for shopping on a website hosted by the web server 104. The customer may, via the chatbot, view items displayed on the website, and may click on items to view detailed descriptions, for example. The website may capture these activities as user session data, and/or transmit the user session data to the chatbot serving device 102 over the communication network 118. The website may also allow the customer to add one or more of the items to an online shopping cart, and allow the customer to perform a “checkout” of the shopping cart to purchase the items. In some examples, the web server 104 transmits purchase data identifying items the customer has purchased from the website to the chatbot serving device 102. In some embodiments, the chatbot serving device 102 itself can directly record the users' online activities like user session data, online purchase data, etc. and may store them in the database 116.

In some embodiments, the chatbot serving device 102 may transmit a query to the web server 104, e.g. upon a message received from a customer. The query may be sent standalone or together with data related to the customer, e.g. customer ID. In some examples, the query may indicate a search request for items that match the query and related to the user's transaction history, e.g. previously purchased by the user. The web server 104 may run a search engine to identify one or more items in response to the search request.

In some embodiments, the chatbot serving device 102 may determine based on the query that the user has an intent for expedited transaction, e.g. by identifying in the query a predetermined keyword indicating an expedited request of a product item by the user. The predetermined keyword may be “now,” “asap,” or any other word indicating a speedy transaction. Once the predetermined keyword is detected, the chatbot serving device 102 can enable a “Buy-Now” feature to directly generate contract data related to a purchase contract of the product item, and transmit, as a response to the query, the contract data with an option for the user to select to directly place an order of the product item.

In some examples, the chatbot serving device 102 may execute one or more models (e.g., algorithms), such as a machine learning model, deep learning model, statistical model, etc., to expedite online transactions. The chatbot serving device 102 may obtain a query and use a natural language understanding model to analyze the query. If the chatbot serving device 102 determines, based on the natural language understanding model, that the user wants to expedite online transactions, the chatbot serving device 102 determines one or more items, e.g. via interaction with the web server 104, based on the query and the user's historical purchasing experience. When a single item is identified for the user's expedited request, the chatbot serving device 102 generates a purchase contract based on a contract generation model, and provides the purchase contract to the user, for the user to directly place an order of the single item. When multiple items are identified for the user's expedited request, the chatbot serving device 102 ranks the multiple items based on a ranking model, and provides some top ranked items to the user.

The chatbot serving device 102 is further operable to communicate with the database 116 over the communication network 118. For example, the chatbot serving device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the chatbot serving device 102, in some examples, the database 116 can be a local storage device, such as a hard drive, a non-volatile memory, or a USB stick. The chatbot serving device 102 may store online purchase data received from the web server 104 or directly from users in the database 116. The chatbot serving device 102 may receive in-store purchase data from different stores 109 and store them in the database 116. The chatbot serving device 102 may also receive from the web server 104 or directly from users, user session data identifying events associated with browsing sessions, and may store the user session data in the database 116. The chatbot serving device 102 may also generate a Buy-Now contract immediately after a user indicates an expedited request of a product item, and may store data related to the Buy-Now contract in the database 116.

In some examples, the chatbot serving device 102 generates training data for a plurality of models (e.g., machine learning models, deep learning models, statistical models, algorithms, etc.). The chatbot serving device 102 trains the models based on training data, and stores the models in a database, such as in the database 116 (e.g., a cloud storage). In some embodiments, the chatbot serving device 102 may perform model training upon a request from the web server 104. In some embodiments, the chatbot serving device 102 may perform model training automatically or periodically based on a pre-configuration. The training data may include user feedbacks after using the buy-now feature.

The models, when executed by the chatbot serving device 102, allow the chatbot serving device 102 to expedite online transactions. In some examples, the chatbot serving device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the chatbot serving device 102 may expedite online transactions.

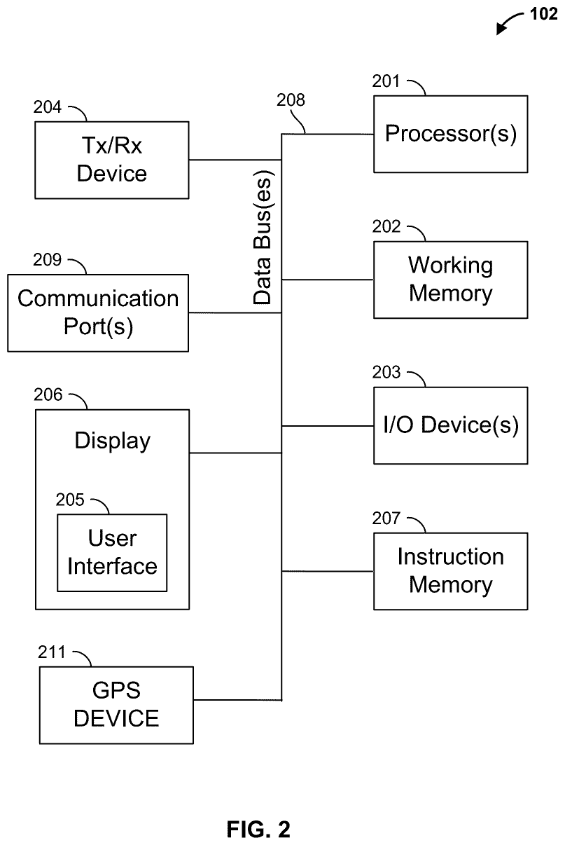

FIG. 2 illustrates a block diagram of a chatbot serving device, e.g. the chatbot serving device 102 of FIG. 1, in accordance with some embodiments of the present teaching. In some embodiments, each of the chatbot serving device 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the chatbot serving device 102 can be combined, omitted, and/or replicated. In addition, it will be appreciated that additional elements other than those illustrated in FIG. 2 can be added to the chatbot serving device 102.

As shown in FIG. 2, the chatbot serving device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the chatbot serving device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the chatbot serving device 102 can include a single memory unit configured to operate as both instruction memory and working memory. Further, although embodiments are discussed herein including non-volatile memory, it will be appreciated that the chatbot serving device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the chatbot serving device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the chatbot serving device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the chatbot serving device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the chatbot serving device 102 and/or the web server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the chatbot serving device 102 may determine a local geographical area (e.g., town, city, state, etc.) of its position.

In some embodiments, the chatbot serving device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

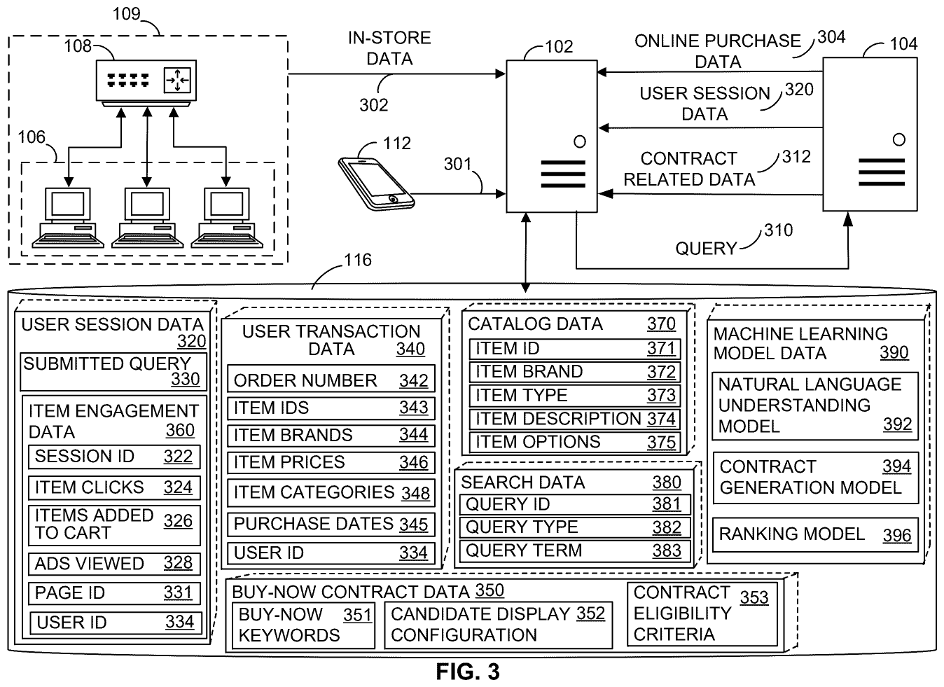

FIG. 3 is a block diagram illustrating various portions of a system for expediting online transactions, e.g. the system shown in the network environment 100 of FIG. 1, in accordance with some embodiments of the present teaching. As indicated in FIG. 3, the chatbot serving device 102 may receive user session data 320 and online purchase data 304 from the web server 104. The user session data 320 identifies, for each user (e.g., customer), data related to that user's browsing session, such as when browsing a retailer's webpage hosted by the web server 104. The chatbot serving device 102 may store the user session data 320 into the database 116.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed and/or clicked during the browsing session, page ID 331 identifying a webpage (product page, search result page, home page, etc.) the user engaged with, and user ID 334 (e.g., a customer ID, retailer website login ID, a cookie ID, etc.). The submitted query data 330 may identify one or more searches conducted by a user during a browsing session (e.g., a current browsing session).

The online purchase data 304 may identify and characterize one or more online purchases, such as purchases made by the user and other users via a retailer's website hosted by the web server 104. The chatbot serving device 102 may also receive in-store data 302 from the store 109, which identifies and characterizes one or more in-store purchases, in-store advertisements, in-store shopping data, etc. In some embodiments, the in-store data 302 may also indicate availability of items in the store 109, and/or user IDs that have selected the store 109 as a default store for picking up online orders.

The chatbot serving device 102 may parse the in-store data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more attributes of a plurality of queries submitted by users on the website hosted by the web server 104 and/or on a website of a search engine associated with the web server 104. The search data 380 may include, for each of the plurality of queries, a query ID 381 identifying a query previously submitted by users, a query type 382 (e.g., a head query, a torso query, or a tail query), and query term 383 identifying terms in a query.

In some embodiments, the database 116 may further store buy-now contract data 350, which may identify data related to buy-now contracts created or to be created in response to a user's expedited request of a product item. The buy-now contract data 350 may include buy-now keywords 351 identifying keywords that indicate speedy or expedited transaction request when being detected in a query, candidate display configuration 352 identifying configurations for displaying candidate items to be selected for a speedy or expedited transaction, contract eligibility criteria 353 identifying criteria used to determine whether a user is eligible for having a buy-now purchase contract for speedy or expedited transaction.

The database 116 may also store machine learning model data 390 identifying and characterizing one or more machine learning models and related data for expediting online transactions. For example, the machine learning model data 390 may include a natural language understanding model 392, a contract generation model 394, and a ranking model 396.

In some embodiments, the natural language understanding model 392 may include one or more machine-learning generated speech models to provide natural language understanding of an input, e.g. a query input by a user with text or utterance. The natural language understanding model 392 may be trained to understand different aspects of a query, e.g. product, brand, quantity, time, location, etc. For example, the natural language understanding model 392 may be used to determine that the user has an intent to expedite online transaction, by identifying, in the query, a predetermined keyword indicating a speedy or expedited transaction request. In addition, the natural language understanding model 392 may also be used to determine, in the query, a product portion related to product items to be searched. The keyword indicating a speedy or expedited transaction request, and other keywords indicating quantity, time, location, delivery method, shipping fee, etc., will not be within the product portion. In some embodiments, the natural language understanding model 392 may be built based on a neural network.

In some embodiments, the contract generation model 394 is used to generate a contract for a user to purchase a product item. The chatbot serving device 102 may use the contract generation model 394 to determine whether is a buy-now contract is eligible and available to the user, based on e.g. whether a query submitted by the user contains a predetermined buy-now keyword, whether a single product item is identified based on the query and the user's purchase history, whether the product item can be shipped to the user, whether the user is choosing shipping as a delivery option for the product item, whether the user has previously saved shipping address and payment method, whether the user has a free shipping membership, etc. Based on the determination, the contract generation model 394 can be used to generate either a normal purchase contract or a buy-now contract to bypass cart actions.

In some embodiments, the ranking model 396 may be used to rank candidate items for a given query submitted by a user, when multiple items are identified based on the given query and the user's transaction history. The ranking may be based on at least one of: a matching score identifying a matching between each candidate item and the given query, a recall score identifying whether a candidate item was purchased by the user before, a frequency score identifying how often a candidate item was purchased by the user before, etc.

In some examples, the chatbot serving device 102 receives (e.g., in real-time) a message 301, which may include a query 310, from a user via the user device 112. The chatbot serving device 102 may forward the query 310, together with information about the user, to the web server 104, which can send contract related data 312 as a response. The contract related data 312 may include the buy-now contract data 350, transaction history data of the user, and/or search results matching the query 310.

The chatbot serving device 102 may determine whether the query 310 contains one of the buy-now keywords 351, to determine whether the user is requesting an expedited transaction. If the query 310 contains one of the buy-now keywords 351, the chatbot serving device 102 also tries to identify an item that matches the query 310 and was purchased by the user before (or the user showed an intent to buy this item by adding to cart, etc.). If a single item is identified in this manner, the chatbot serving device 102 can generate a buy-now contract based on the contract related data 312, as a direct response to the message 301. If multiple items are identified in this manner, the chatbot serving device 102 can rank the identified items and provide the top ranked items to the user, as a direct response to the message 301.

In some embodiments, the chatbot serving device 102 may assign one or more of the operations described above to a different processing unit or virtual machine hosted by the one or more processing devices 120. Further, the chatbot serving device 102 may obtain the outputs of the these assigned operations from the processing units, and generate the response based on the outputs.

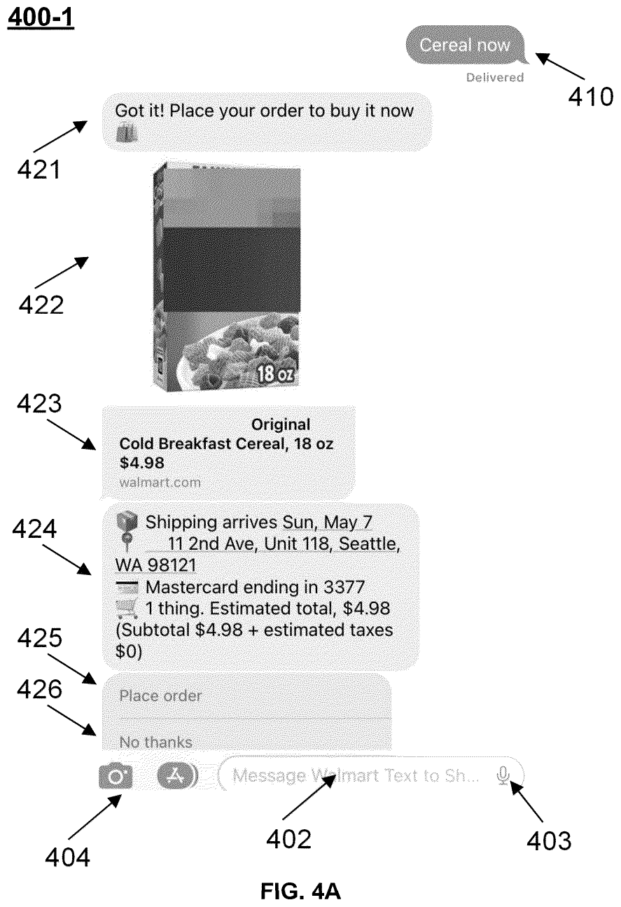

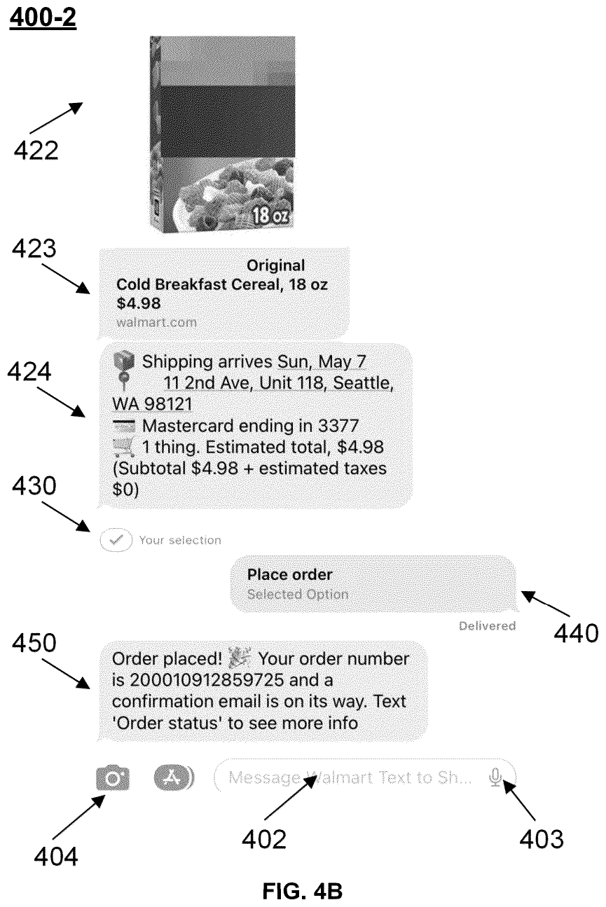

FIGS. 4A-4B illustrate a user interface 400 showing a shopping experience of a user, in accordance with some embodiments of the present teaching. In some embodiments, the user interface 400 is an interface of a chatbot served by a chatbot serving device, e.g. the chatbot serving device 102 in FIG. 1.

As shown in FIG. 4A, the chatbot serving device 102 receives a query 410 reciting “Cereal now,” via the user interface 400-1. In various embodiments, the query 410 may be entered by the user, via a text input at the bar 402, via an utterance input through a voice input function 403, or via an image input through an image uploading function 404.

Based on the query 410, the chatbot determines that the user wants to buy cereal based on the keyword “Cereal” in the query 410; and that the user wants to expedite the checkout process based on the keyword “now” in the query 410. In some embodiments, the chatbot compares each word in the query 410 with each of the buy-now keywords 351, to determine whether any of the buy-now keywords 351 is detected from the query 410. In this case, the keyword “now” is both in the query 410 and in the buy-now keywords 351.

From the beginning of the conversation, the chatbot knows the user's ID and can obtain the user's transaction history accordingly. After determining that the user wants to expedite the checkout process, the chatbot enables a buy-now feature and searches, within the user's transaction history, items matching the query 410.

In this example, the chatbot identifies, from the user's transaction history, one item matching the query 410, an 18-oz Breakfast Cereal. The chatbot responds to the query 410 with a series of outputs 421-426. With a first output 421 reciting “Got it! Place your order to buy it now,” the chatbot indicates that an item is identified based on the query 410 for the user to buy it now. The chatbot then immediately provides a picture of the item in output 422, and a description of the item in output 423.

In output 424, the chatbot provides contract data for the user to buy this item. As shown in FIG. 4A, the contract data includes shipping method, estimated delivery time, shipping address, payment method, and price information. The shipping address and payment method may be previously entered and saved by the user, and can be extracted from the user's account information. In this example, the output 424 shows only the last four digits of the credit card to be used for the order. The price information may include item price, estimated tax, and shipping fee if applicable.

The chatbot then provides two options 425, 426 for the user to choose. If the user wants to accept the contract and buy the item, the user can click the option 425 to place order. If the user does not want to accept the contract, the user can click the option 426 to reject it.

FIG. 4B shows subsequent conversations between the chatbot and the user via the user interface 400-2, continuing from the conversations shown in FIG. 4A. As shown in FIG. 4B, the user selects the option 425 to place order for the identified cereal. Accordingly, the chatbot shows an indication 430 that the user has already made a selection between the options 425, 426. The selection of “place order” itself is also shown as a user input 440. In response to the user input 440, the chatbot places the order for the user, i.e. executing the contract of buying the identified cereal, and provides order number and other related order data to the user in chatbot output 450.

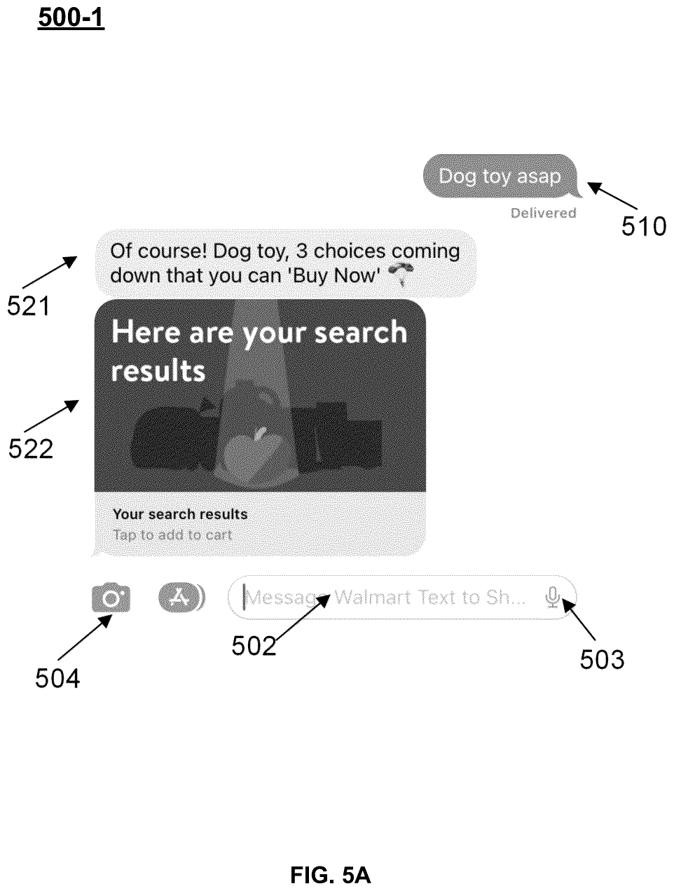

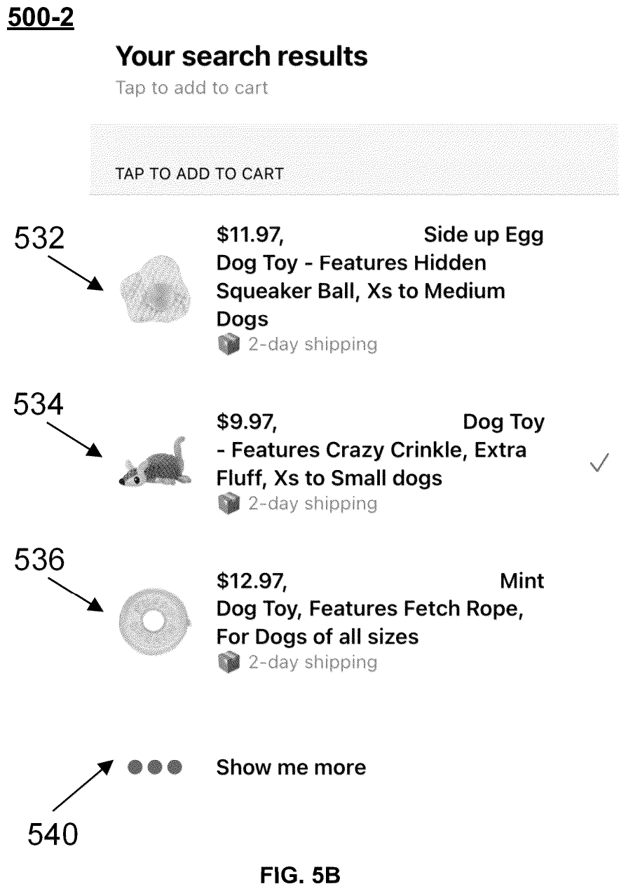

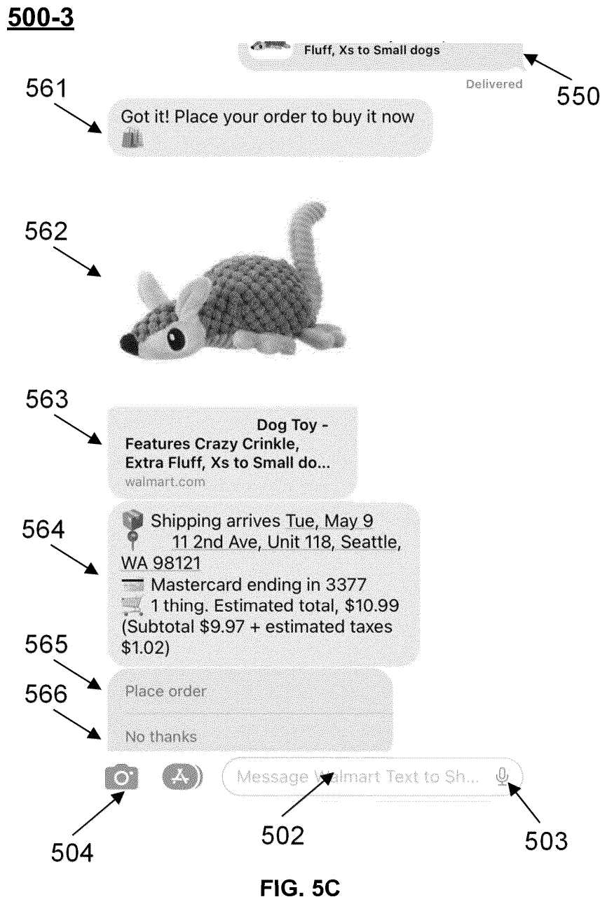

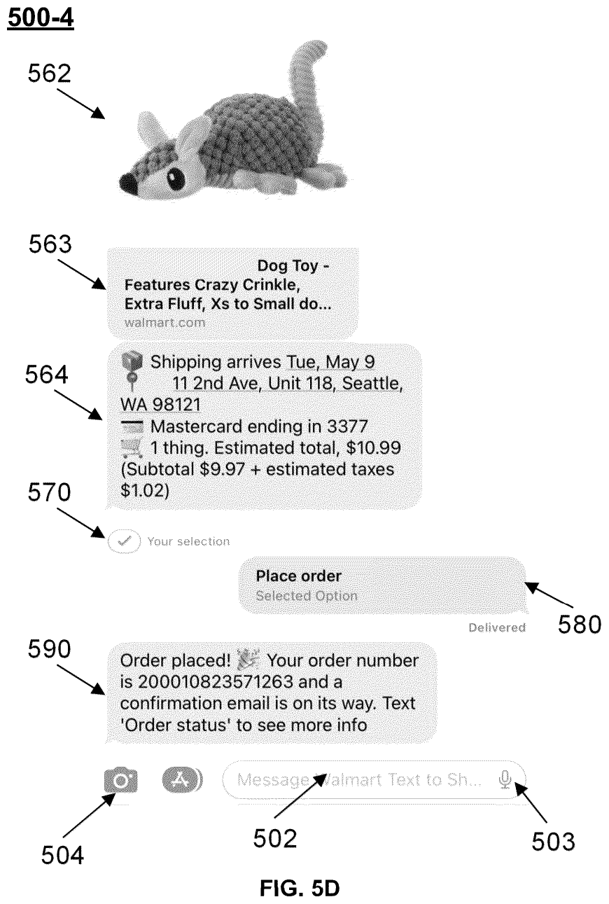

FIGS. 5A-5D illustrate a user interface 500 showing another shopping experience, in accordance with some embodiments of the present teaching. In some embodiments, the user interface 500 is an interface of a chatbot served by a chatbot serving device, e.g. the chatbot serving device 102 in FIG. 1.

As shown in FIG. 5A, the chatbot serving device 102 receives a query 510 reciting “Dog toy asap,” via the user interface 500-1. In various embodiments, the query 510 may be entered by the user, via a text input at the bar 502, via an utterance input through a voice input function 503, or via an image input through an image uploading function 504.

Based on the query 510, the chatbot determines that the user wants to buy a dog toy based on the keywords “Dog toy” in the query 510; and that the user wants to expedite the checkout process based on the keyword “asap” in the query 410. In some embodiments, the chatbot compares each word in the query 510 with each of the buy-now keywords 351, to determine whether any of the buy-now keywords 351 is detected from the query 510. In this case, the keyword “asap” is both in the query 510 and in the buy-now keywords 351.

From the beginning of the conversation, the chatbot knows the user's ID and can obtain the user's transaction history accordingly. After determining that the user wants to expedite the checkout process, the chatbot enables a buy-now feature and searches, within the user's transaction history, items matching the query 510.

In this example, from the user's transaction history, the chatbot cannot identify or nail down to one single item matching the query 510. This may happen when: the user's transaction history does not contain any item that can match the query 510, or the user's transaction history contains multiple items each of which can match the query 510.

In this case, the chatbot responds to the query 510 with a series of outputs 521-522. With a first output 521 reciting “Of course! Dog toy, 3 choices coming down that you can ‘Buy Now’,” the chatbot indicates that the user's request for expedited transaction is recognized; and that the user can choose any of the three items to proceed with the buy-now feature. The chatbot then immediately provides an icon 522 indicating search results for the query 510 such that the user can view the three choices of dog toys by clicking the icon 522.

FIG. 5B shows subsequent conversations between the chatbot and the user via the user interface 500-2, continuing from the conversations shown in FIG. 5A. After the user clicks on the icon 522, three choices of dog toys 532, 534, 536 matching the query 510 are shown in FIG. 5B for the user to select. The chatbot may also provide an option 540 for the user to choose to see more choices of items matching the query 510. In this example, the user selects the dog toy 534 to proceed with the buy-now feature. In some embodiments, the three choices of dog toys 532, 534, 536 may be directly displayed to the user without showing the icon 522 first.

FIG. 5C shows subsequent conversations between the chatbot and the user via the user interface 500-3, continuing from the conversations shown in FIG. 5B. After the user selects the dog toy 534, the selection is shown as a user input 550 in FIG. 5C. In response to the user input 550, the chatbot generates a series of outputs 561-566. With the output 561 reciting “Got it! Place your order to buy it now,” the chatbot indicates that the item is identified based on the user selection to buy it now. The chatbot then immediately provides a picture of the item in output 562, and a description of the item in output 563.

In output 564, the chatbot provides contract data for the user to buy this item. As shown in FIG. 5C, the contract data includes shipping method, estimated delivery date, shipping address, payment method, and price information. The shipping address and payment method may be previously entered and saved by the user, and can be extracted from the user's account information. In this example, the output 564 shows only the last four digits of the credit card to be used for the order. The price information may include item price, estimated tax, and shipping fee if applicable.

The chatbot then provides two options 565, 566 for the user to choose. If the user wants to accept the contract and buy the item, the user can click the option 565 to place order. If the user does not want to accept the contract, the user can click the option 566 to reject it.

FIG. 5D shows subsequent conversations between the chatbot and the user via the user interface 500-4, continuing from the conversations shown in FIG. 5C. As shown in FIG. 5D, the user selects the option 565 to place order for the identified dog toy. Accordingly, the chatbot shows an indication 570 that the user has already made a selection between the options 565, 566. The selection of “place order” itself is also shown as a user input 580. In response to the user input 580, the chatbot places the order for the user, i.e. executing the contract of buying the identified dog toy, and provides order number and other related order data to the user in chatbot output 590.

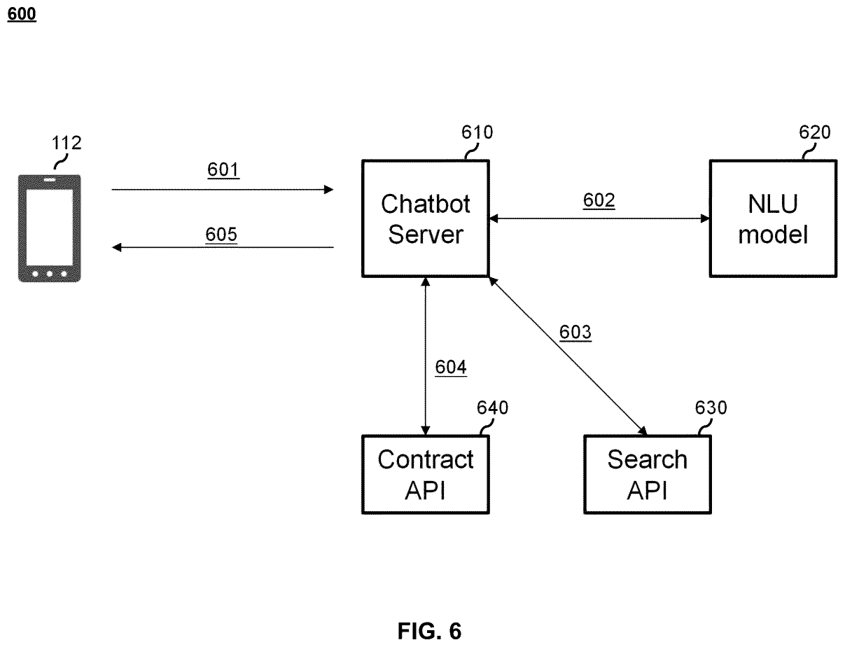

FIG. 6 illustrates an example process 600 for expediting online transactions, in accordance with some embodiments of the present teaching. In some embodiments, the process 600 can be carried out by one or more computing devices, such as the chatbot serving device 102 and/or the cloud-based engine 121 of FIG. 1. The process 600 includes sequential operations 601 to 605 in order.

As shown in FIG. 6, the process 600 starts from operation 601, where a user uses the user computing device 112 to input a query via a chatbot served by a chatbot server 610. In some embodiments, the chatbot server 610 may be part of the chatbot serving device 102. The query may be a text or utterance input by the user.

In some embodiments, the chatbot server 610 calls a natural language understanding (NLU) model 620 at operation 602 to understand the query. The NLU model 620 may be part of the chatbot serving device 102, part of the web server 104, in a standalone server, or part of the natural language understanding model 392 in the database 116, according to various embodiments. The NLU model 620 can interpret a query and identifies intents or actions a customer likes to take by entering the query. The NLU model 620 is trained with customer queries to recognize the intents based on their similarity with the training data. To adapt to the “buy-now” feature, the NLU model 620 is trained to recognize “buy now” as a new intent. Templates and business rules may be added during training to avoid regressions due to a similarity between “buy now” and “buy”.

In this example, the NLU model 620 can be used to determine that the query input by the user contains one or more keywords indicating an expedited transaction request, e.g. keywords like “now,” “asap,” “as soon as possible,” “today,” “tomorrow,” or any other word that can signify speed or time for the shopping process. The keyword may be located anywhere in the query. For example, queries like “buy paper towel now,” “milk asap 1 gallon,” “2 vitamin C today,” all indicate an expedited transaction request.

After the NLU model 620 detects a buy-now keyword in the query, the chatbot server 610 determines that the user has a buy-now intent. As such, the chatbot server 610 enables the buy-now feature and calls a search API 630 of a search engine at operation 603 to search for items that are buy-now eligible. The search API 630 may be part of the chatbot serving device 102, part of the web server 104, or in a standalone server, according to various embodiments. In some embodiments, an item is buy-now eligible when at least one of the following is true: the item offers a shipping delivery option for the user's previously saved address, the item is in the user's transaction history, and the item matches the query. For example, given a query “cereal now,” the search API 630 returns the user's favorite cereal based on the buy-now eligible items. This favorite cereal may be the only cereal purchased by the user before, the cereal most frequently purchased by the user, or the cereal most recently purchased by the user.

Given the identified item returned from the search API 630, the chatbot server 610 invokes a contract API 640 at operation 604, to obtain additional contract details like: shipping address, credit card information, total price, etc. The contract API 640 may be part of the chatbot serving device 102, part of the web server 104, or in a standalone server, according to various embodiments. Based on the information obtained from the contract API 640, the chatbot server 610 can generate a buy-now contract for the identified item.

At operation 605, the chatbot server 610 presents information of the buy-now contract for the identified item to the user, via a review screen on a user interface of the chatbot. In the review screen, the chatbot server 610 also provides the user two options: e.g. “Place order” and “No thanks.” If the customer chooses “Place order,” then the order is placed and confirmation is sent to the user via the chatbot. If the customer chooses “No thanks,” then the chatbot server 610 may send to the user a friendly message saying the order was not placed.

The entire process 600 does not impact the online shopping cart of the user at all. That is, the identified item is never being added to or removed from the user's cart through the process 600.

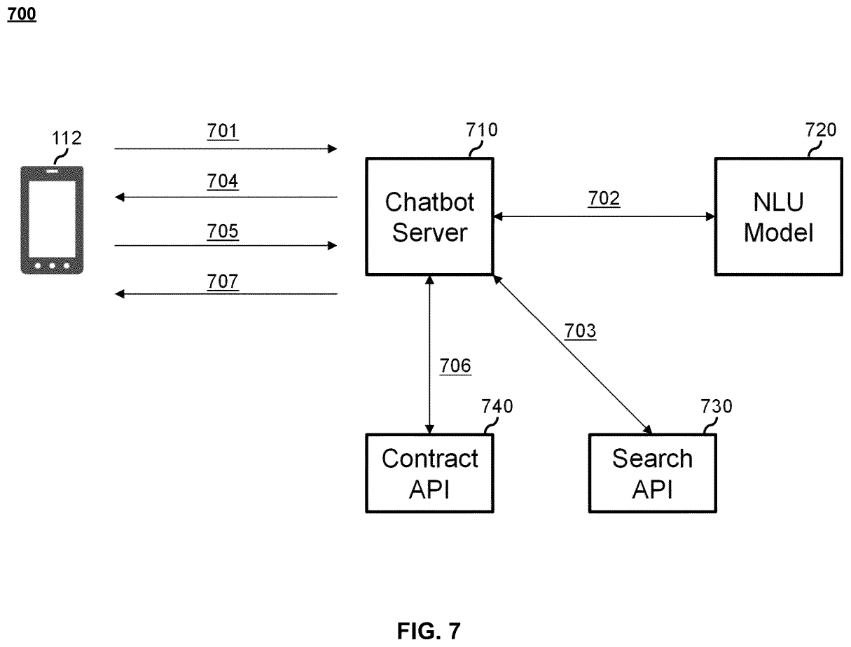

FIG. 7 illustrates another example process 700 for expediting online transactions, in accordance with some embodiments of the present teaching. In some embodiments, the process 700 can be carried out by one or more computing devices, such as the chatbot serving device 102 and/or the cloud-based engine 121 of FIG. 1. The process 700 includes sequential operations 701 to 707 in order.

As shown in FIG. 7, the process 700 starts from operation 701, where a user uses the user computing device 112 to input a query via a chatbot served by a chatbot server 710. In some embodiments, the chatbot server 710 may be part of the chatbot serving device 102. The query may be a text or utterance input by the user.

In some embodiments, the chatbot server 710 calls a natural language understanding (NLU) model 720 at operation 702 to understand the query. The NLU model 720 may be part of the chatbot serving device 102, part of the web server 104, in a standalone server, or part of the natural language understanding model 392 in the database 116, according to various embodiments. The NLU model 720 can function and be trained similarly as the NLU model 620.

In this example, the NLU model 720 can be used to determine that the query input by the user contains one or more keywords indicating an expedited transaction request, e.g. keywords like “now,” “asap,” “as soon as possible,” “today,” “tomorrow,” or any other word that can signify speed or time for the shopping process. The keyword may be located anywhere in the query.

After the NLU model 720 detects a buy-now keyword in the query, the chatbot server 710 determines that the user has a buy-now intent. As such, the chatbot server 710 enables the buy-now feature and calls a search API 730 of a search engine at operation 703 to search for items that are buy-now eligible. The search API 730 may be part of the chatbot serving device 102, part of the web server 104, or in a standalone server, according to various embodiments. In some embodiments, an item is buy-now eligible when at least one of the following is true: the item offers a shipping delivery option, the item is in the user's transaction history, and the item matches the query.

In this example, the search API 730 does not find the user's favorite item from the buy-now eligible items. This may be because: the user did not buy an item matching the query, or the user has purchased multiple items matching the query but none of the multiple items can be determined to be the user's favorite. In this case, the chatbot server 710 presents at operation 704, via a user interface of the chatbot, several options for the user to choose from. For example, three options may be presented. The number three is pre-determined by the system, and can be a different number according to various embodiments.

In some embodiments, when the user has purchased three or more items matching the query but none of these items can be determined to be the user's favorite, the chatbot server 710 may determine a ranking for these items, e.g. based on the ranking model 396 in the database 116. Then, the chatbot server 710 may pick the top three ranked items and present them to the user at the operation 704.

In some embodiments, when the user has purchased two items matching the query but none of these items can be determined to be the user's favorite, the chatbot server 710 may determine a ranking for items matching the query but not in the user's purchase history, e.g. based on the ranking model 396 in the database 116. Then, the chatbot server 710 may pick the top ranked non-purchased item and present it together with the two purchased items to the user at the operation 704.

The chatbot server 710 then receives, at operation 705, the user's selection of one of the three presented items, using the user computing device 112 via the user interface of the chatbot. Given the selected item from the user, the chatbot server 710 invokes a contract API 740 at operation 706, to obtain additional contract details like: shipping address, credit card information, total price, etc. The contract API 740 may be part of the chatbot serving device 102, part of the web server 104, or in a standalone server, according to various embodiments. Based on the information obtained from the contract API 740, the chatbot server 710 can generate a buy-now contract for the selected item.

At operation 707, the chatbot server 710 presents information of the buy-now contract for the selected item to the user, via a review screen on a user interface of the chatbot. In the review screen, the chatbot server 710 also provides the user two options: e.g. “Place order” and “No thanks.” If the customer chooses “Place order,” then the order is placed and confirmation is sent to the user via the chatbot. If the customer chooses “No thanks,” then the chatbot server 710 may send to the user a friendly message saying the order was not placed.

Users may be notified of the “Buy-Now” feature of a chatbot in different manners. In a first manner, the chatbot may send a message via the chatbot to a user to explain the “Buy-Now” feature and how to use it. In a second manner, the system may send an email to a user of the chatbot or a website associated with the chatbot, to notify them about the “Buy-Now” feature and how to use it. In a third manner, for users who have many grocery shopping experiences, users who have premium memberships with free shipping feature, users who are shopping for items available for shipping, users who often add to cart and go to checkout immediately after receiving a search result, and/or users who have not used the “Buy-Now” feature for more than a time period (e.g. 30 days), the system can send a notification to tell them about the possibility and method of using the “Buy-Now” feature via the chatbot. The notification may be sent after a completed action of the chatbot in response to a user request. The notification may be sent only once in a conversation chain with a customer. The notification may be sent only when the customer is accessing the chatbot or channel for online shopping.

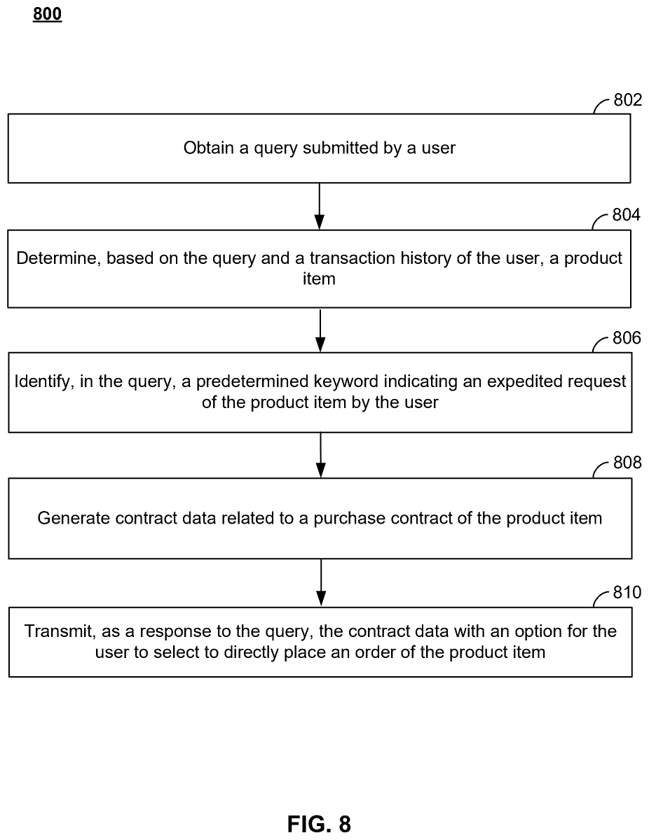

FIG. 8 is a flowchart illustrating an example method 800 for expediting online transactions, in accordance with some embodiments of the present teaching. In some embodiments, the method 800 can be carried out by one or more computing devices, such as the chatbot serving device 102 and/or the cloud-based engine 121 of FIG. 1. Beginning at operation 802, a query submitted by a user is obtained. Based on the query and a transaction history of the user, a product item is determined at operation 804. A predetermined keyword indicating an expedited request of the product item by the user is identified at operation 806 in the query. At operation 808, contract data related to a purchase contract of the product item is generated. As a response to the query, the contract data is transmitted at operation 810 with an option for the user to select to directly place an order of the product item.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain a query submitted by a user,
identify, in the query, at least one predetermined keyword indicating a request for an expedited transaction by the user,
determine, based on the query and a transaction history of the user, a product item,
generate contract data related to a purchase contract of the product item, and
transmit, as a response to the query, the contract data with an option for the user to select to directly place an order of the product item.

2. The system of claim 1, wherein:
the query is obtained via a chatbot; and
the query includes a text or an utterance input by the user via the chatbot.

3. The system of claim 1, wherein:
the at least one predetermined keyword signifies speed or time for a shopping process; and
the at least one predetermined keyword is identified based on a natural language model that is trained based on historical customer queries and historical transaction data.

4. The system of claim 1, wherein the product item is determined based on:
searching for at least one eligible item regarding the expedited transaction based on one or more criteria; and
selecting the product item from the at least one eligible item.

5. The system of claim 4, wherein an item is an eligible item regarding the expedited transaction when:
the item offers a shipping delivery option for the user's previously saved address;
the item is in the user's transaction history; and
the item matches the query.

6. The system of claim 4, wherein:
the product item is a single item identified to be eligible based on the searching with the one or more criteria; and
the contract data is provided to the user as a direct response to the query.

7. The system of claim 6, wherein:
the contract data is generated based on the user's voluntarily saved information via a website or a chatbot application; and
the contract data is provided for the user to place an order of the product item directly by a single click.

8. The system of claim 4, wherein:
a plurality of eligible items are determined based on the searching with the one or more criteria; and
the product item is selected from the plurality of eligible items based on:
ranking the plurality of eligible items based on at least one of: a matching score identifying a matching between each eligible item and the query, a recall score identifying whether each eligible item was purchased by the user before, a frequency score identifying how often each eligible item was purchased by the user before,
providing a predetermined number of top-ranked eligible items to the user,
obtaining a selection from the user regarding the predetermined number of top-ranked eligible items, and
selecting the product item based on the selection from the user.

9. The system of claim 8, wherein:
the contract data is generated based on the user's voluntarily saved information via a website or a chatbot application; and
the contract data is provided for the user to place an order of the product item directly by a single click.

10. The system of claim 1, wherein the instructions, when executed, further cause the processor to:
determine, for a plurality of users, whether each user is eligible for having a purchase contract for an expedited transaction based on at least one of: a number of grocery shopping experiences of the user, whether the user has a retail membership with free shipping feature, or a frequency for the user to add an item to cart and go to checkout immediately after receiving a search result; and
transmit notifications to eligible users to indicate their eligibility, possibility and manner of requesting an expedited transaction.

11. A computer-implemented method, comprising:
obtaining a query submitted by a user;
identifying, in the query, at least one predetermined keyword indicating a request for an expedited transaction by the user;
determining, based on the query and a transaction history of the user, a product item;
generating contract data related to a purchase contract of the product item; and
transmitting, as a response to the query, the contract data with an option for the user to select to directly place an order of the product item.

12. The computer-implemented method of claim 11, wherein:
the query is obtained via a chatbot; and
the query includes a text or an utterance input by the user via the chatbot.

13. The computer-implemented method of claim 11, wherein:
the at least one predetermined keyword signifies speed or time for a shopping process; and
the at least one predetermined keyword is identified based on a natural language model that is trained based on historical customer queries and historical transaction data.

14. The computer-implemented method of claim 11, wherein determining the product item comprises:
searching for at least one eligible item regarding the expedited transaction based on one or more criteria; and
selecting the product item from the at least one eligible item.

15. The computer-implemented method of claim 14, wherein an item is an eligible item regarding the expedited transaction when:
the item offers a shipping delivery option for the user's previously saved address;
the item is in the user's transaction history; and
the item matches the query.

16. The computer-implemented method of claim 14, wherein:
the product item is a single item identified to be eligible based on the searching with the one or more criteria; and
the contract data is provided to the user as a direct response to the query.

17. The computer-implemented method of claim 16, wherein:
the contract data is generated based on the user's voluntarily saved information via a website or a chatbot application; and
the contract data is provided for the user to place an order of the product item directly by a single click.

18. The computer-implemented method of claim 14, wherein:
a plurality of eligible items are determined based on the searching with the one or more criteria; and
the product item is selected from the plurality of eligible items based on:
ranking the plurality of eligible items based on at least one of: a matching score identifying a matching between each eligible item and the query, a recall score identifying whether each eligible item was purchased by the user before, a frequency score identifying how often each eligible item was purchased by the user before,
providing a predetermined number of top-ranked eligible items to the user,
obtaining a selection from the user regarding the predetermined number of top-ranked eligible items, and
selecting the product item based on the selection from the user.

19. The computer-implemented method of claim 11, further comprising:
determining, for a plurality of users, whether each user is eligible for having a purchase contract for an expedited transaction based on at least one of: a number of grocery shopping experiences of the user, whether the user has a retail membership with free shipping feature, or a frequency for the user to add an item to cart and go to checkout immediately after receiving a search result; and
transmitting notifications to eligible users to indicate their eligibility, possibility and manner of requesting an expedited transaction.

20. A non-transitory computer readable medium having instructions stored thereon, wherein the instructions, when executed by at least one processor, cause at least one device to perform operations comprising:
obtaining a query submitted by a user;
identifying, in the query, at least one predetermined keyword indicating a request for an expedited transaction by the user;
determining, based on the query and a transaction history of the user, a product item;
generating contract data related to a purchase contract of the product item; and
transmitting, as a response to the query, the contract data with an option for the user to select to directly place an order of the product item.
